(19) United States
(12) Patent Application Publication
(10) Pub. No.: US 2002/0073204 A1
(43) Pub. Date: Jun. 13, 2002

(54) Method and system for exchange of node characteristics for DATA sharing in peer-to-peer DATA networks

(76) Inventors: Rabindranath Dutta, Austin, TX (US); Janani Janakiraman, Austin, TX (US)

Correspondence Address: Joseph R. Burwell, Law Office of Joseph R. Burwell, P.O. Box 28022, Austin, TX, 78755-8022, US

(21) Appl. No.: 09/732,481

(22) Filed: Dec. 7, 2000

(51) Int. Cl. G06F 15/16

(52) U.S. Cl. 709/227; 709/204

(57) ABSTRACT

A method and system is presented for allowing a user of a data sharing application in a peer-to-peer network to review node characterizing data of a node/host that is connected to the user's node. After the data sharing application has received the node characterizing data that describes various characteristics of the connected node, the node characterizing data is presented to the user. After viewing the data, the user is able to decide whether or not the peer-to-peer data sharing application should remain connected to the other node, thereby allowing the user to eliminate unnecessary data traffic and optimize the user's connections and search time.

### BACKGROUND OF THE INVENTION

1. Field of the Invention

The present invention relates to an improved data processing system and, in particular, to a method and system for multicomputer data transferring. Still more particularly, the present invention provides a method and system for computer-to-computer session/connection establishing or session/connection parameter setting.

2. Description of Related Art

The amount of Internet content continues to grow rapidly and to outpace the ability of search engines to index the exploding amount of information. The largest search engines cannot keep up with the growth as it has been estimated that search engines only index about 5% to 30% of the information content on the Web. Hence, at the current time, the majority of Web content is not classified or indexed by any search engine.

There are currently two broad categories of systems which provide the service of categorizing and locating information on the Web: (1) search engines that return direct hits to sites containing data that match inputted queries, such as AltaVista; (2) Web portals that organize the information into categories and directories, such as Yahoo!. These systems operate using a traditional client-server model with packet-switched data interchange.

Recently, the traditional Web client-server paradigm has been challenged by distributed content-sharing or file-sharing systems that support a peer-to-peer model for exchanging data. In peer-to-peer networks, each computer platform, or node, can operate as a hub, i.e., each node has both client functionality and server functionality. Each node has a list of addresses, most commonly Internet Protocol (IP) addresses, of several other nodes, or “peer nodes”. These nodes can directly communicate with each other without a central or intermediate server.

Nodes within a peer-to-peer network form a distributed file-sharing system in which the nodes act cooperatively to form a distributed search engine. When a user at a node enters a search query, the search query is copied and sent to its list of peer nodes. Each peer node searches its own databases in an attempt to satisfy the search query. Each node copies the query to each node in its list of peer nodes while observing a time-to-live value in the query message. If a resulting query hit is made, then the node returns some type of query results to the originating node. The search quickly fans out amongst a large number of nodes, which provides a useful manner for finding new content that has not yet been indexed by the large search engines.

In a peer-to-peer data sharing network, each node participates in a process of connecting and disconnecting with other nodes. When a connection is established with another node, a user cannot quickly determine whether or not it is worth browsing the content of the newly connected peer node. Since the search might fan out within a widely distributed network, the search can often reach nodes that do not contain any content that would be of interest to the user.

In addition, although the fan-out across an entire distributed peer-to-peer network made be large, a given node has a limited number of connections that it can support at the same time. Eliminating uninteresting or unproductive connections would speed up a user's search for relevant content.

Therefore, it would be advantageous to provide a method and system for allowing a user to limit connections within a peer-to-peer data sharing network to those nodes that contain relevant or interesting content. It would be particularly advantageous to allow a user to eliminate unproductive connections to enhance the speed of the search.

### SUMMARY OF THE INVENTION

A method, apparatus, system, and computer program product for operating a data sharing application in a peer-to-peer network is presented. The data sharing application executes on a source node, and the source node establishes a connection with a target node in the peer-to-peer network. The application may automatically send a request for node characterizing data from the source node to the target node in response to establishing the connection with the target node. The source node subsequently receives node characterizing data from the target node. The node characterizing data is then presented within the application at the source node. The node characterizing data may contain a variety of information that characterizes the target node, such as an optimal connect schedule, information classification for data available to be shared by the target node, information topology data associated with a node connected to the target node, etc. After viewing the data, the user is able to decide whether or not the peer-to-peer data sharing application should remain connected to the target node, thereby allowing the user to eliminate unnecessary data traffic and optimize the user's connections and search time.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2A is a block diagram that depicts a simplified, Internet-based connection between two computers;

FIG. 2B is a block diagram that depicts software components within two computers that are operating as nodes within a peer-to-peer network;

FIG. 2C is a block diagram depicting typical software subcomponents within a peer-to-peer software component that contains file sharing functionality;

FIG. 2D is a block diagram depicting a typical network topology of nodes within a peer-to-peer network;

FIG. 3 depicts a GUI window for a typical peer-to-peer data sharing application;

FIG. 4 is a block diagram depicting a data exchange transaction between two nodes in a peer-to-peer data sharing network in accordance with a preferred embodiment of the present invention;

FIG. 5 depicts the node characterizing information within a thumbnail message in accordance with a preferred embodiment of the present invention;

FIG. 6 is a diagram depicting a GUI window for a peer-to-peer data sharing application in accordance with the present invention; and

FIG. 7 is a flowchart depicting a process for gathering node characterizing information from a node within a peer-to-peer network.

### DETAILED DESCRIPTION OF THE INVENTION

The present invention provides a method and system for allowing a user to limit connections within a peer-to-peer data sharing network to those nodes that contain relevant or interesting content. In addition, a user can eliminate unproductive connections to enhance the speed of the search. As background, a typical organization of hardware and software components within a distributed data processing system is described prior to describing the present invention in more detail.

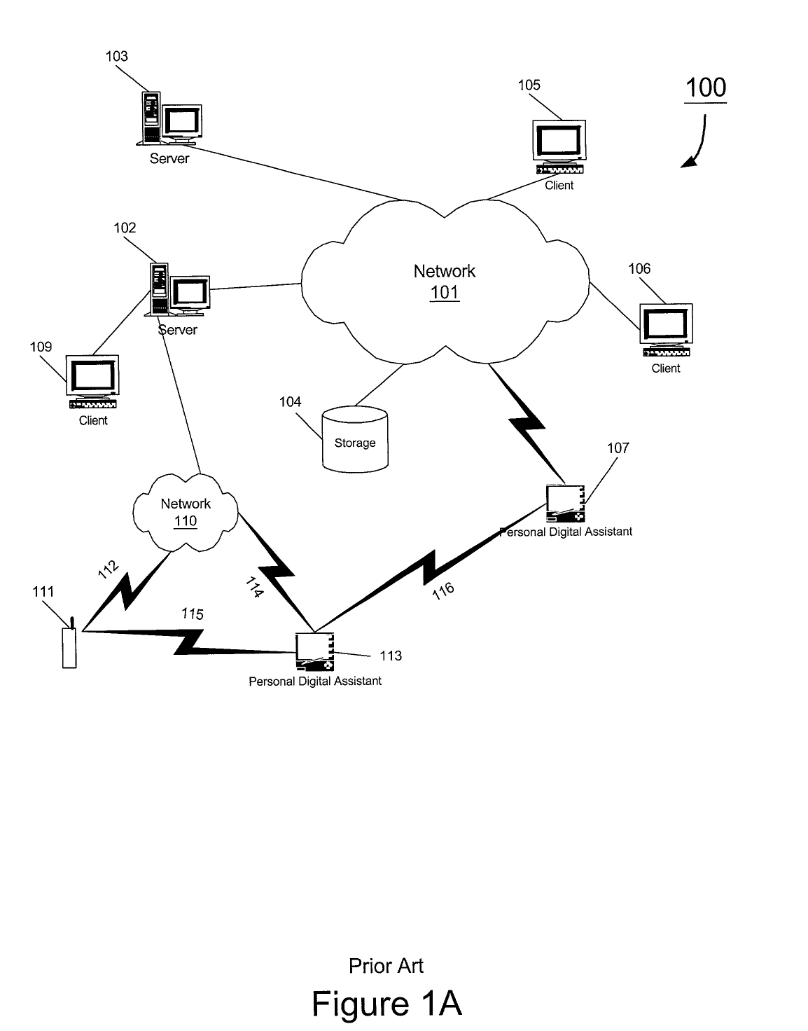

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 117 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. Hence, it should be noted that the distributed data processing system shown in FIG. 1A is contemplated as being fully able to support a variety of peer-to-peer subnets and peer-to-peer services.

The present invention may be implemented on a variety of hardware and software platforms, as described above. More specifically, though, the present invention is directed to providing a method and system for accessing information on a network that includes peer-to-peer networks or subnets. As background, a typical organization of software components within a peer-to-peer network is described prior to describing the present invention in more detail.

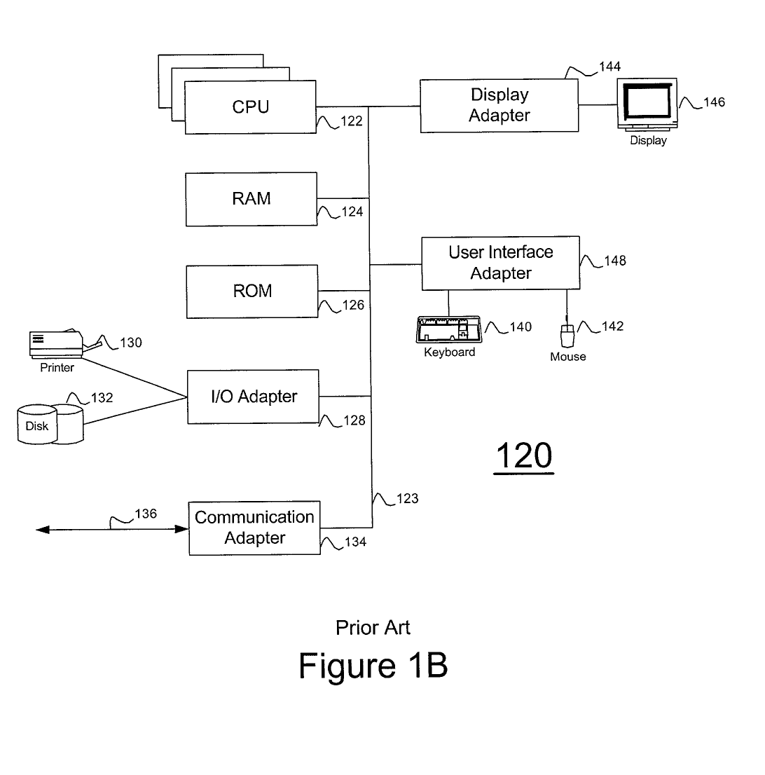

With reference now to FIG. 2A, a block diagram depicts a simplified, Internet-based connection between two computers. Computer 202 communicates with ISP (Internet Service Provider) 204 across communication link 206, and computer 208 communicates with ISP 204 across communication link 210. Users of computers 202 and 208 can employ browsers and other networked applications, such as a peer-to-peer file sharing application, to send and receive information across a network, which includes the Internet in this example.

With reference now to FIG. 2B, a block diagram depicts software components within two computers that are operating as nodes within a peer-to-peer network. Computer 210 has network-enabled applications 212 that use operating system 214 for various services, such as network communication services provided by communications layer 216. In addition, peer-to-peer component 218 may be a stand-alone applet or an application that provides peer-to-peer networking functionality to computer 210. Communication link 220 supports data traffic between computer 210 and computer 230, which has software components that correspond to those shown in computer 210: applications 232, operating system 234, communications layer 236, and peer-to-peer component 238. Peer-to-peer components 218 and 238 may provide support for a distributed, peer-to-peer file sharing function, as shown in more detail in FIG. 2C.

With reference now to FIG. 2C, a block diagram depicts typical software subcomponents within a peer-to-peer software component that contains file sharing functionality. As noted previously, in peer-to-peer networks, each computer platform, or node, can operate as a hub, i.e., each node has both client functionality and server functionality. Peer-to-peer component 250 contains client subcomponent 252 and server subcomponent 254.

The method by which nodes in a peer-to-peer network connect with each other may vary with the type of peer-to-peer network. Generally, a client is dynamically assigned an IP address by an ISP when the client connects to the ISP, so the IP address possibly changes with each client session. In some implementations, a peer-to-peer connection between nodes in a peer-to-peer network is initiated when a user at a node manually enters either a domain name or an IP address (and optionally a port number) of an application of another node that is known to support peer-to-peer networking. The peer-to-peer application then establishes a connection with the other node at the specified address as a starting point within the network. For example, applications using the Gnutella protocol operate in this manner. Gnutella nodes also exchange connection speed, such as connection speed 256, that describe the speed of the network connection that is being used by the node. It should be noted, however, that the present invention can be implemented on a variety of peer-to-peer networks and is not limited by the peer-to-peer protocol that is used by the file sharing applications.

Nodes within a peer-to-peer network can act as a distributed file sharing system in which the nodes act cooperatively to form a distributed search engine. Client subcomponent 252 contains input query processing function 258 and search result processing function 260. When a user at a node enters a search query, the search query is copied to a list of peer nodes to which the node is connected, such as connection host list 262.

When a node receives the query, its server component, such as server component 254, processes the query. Each peer node searches its own databases in an attempt to satisfy the search query. Alternatively, a user has previously specified a list of files that the user is willing to export or share, such as file list 264, and the server subcomponent searches this list to find one or more files that satisfy the search query. Alternatively, rather than searching through a list of file names, the application may search the node's permanent storage for content that matches the search query. Depending on certain parameters within the query message, the node also forwards the query, e.g., by using message processing subcomponent 266, to each node in its list of connected peer nodes. If a resulting query hit is made, then the node returns some form of query results to the peer node that contacted it or to the originating node. In this manner, the search quickly fans out amongst a large number of nodes.

With reference now to FIG. 2D, a block diagram depicts a typical network topology of nodes within a peer-to-peer network. Peer node 270 has a connection host list 272 that identifies nodes 274-278 to which peer node 270 is connected, and nodes 274-278 have their own connection host lists 280-284, respectively. In this example, node 274 connects to nodes 290-293, and node 292 connects with nodes 294-298.

It should be noted that peer-to-peer networks do not have a structured topology, such as a strictly hierarchical organization amongst the nodes. In this example, node 276 also connects with node 293, and node 278 also connects with node 298. However, in order to distinguish immediately connected nodes from distant nodes, the set of nodes to which a particular node connects may be termed the “root nodes” of the particular node.

As noted above, the present invention is not limited to any particular peer-to-peer protocol that is used to implement the present invention. As background information, though, the Gnutella protocol is described in more detail as an example of the manner in which information may be passed in a peer-to-peer network between nodes that support a file sharing application. Reference may be made to the above description for FIG. 2C and FIG. 2D for components that would support file sharing within a peer-to-peer network using a protocol similar to Gnutella.

Gnutella is an Internet-based file searching/sharing program that combines both search engine functionality and file server functionality in a single application. When a user enters a search term into a Gnutella-enabled application at a node in the peer-to-peer network, a query message is generated with the appropriately formatted information, and the message is sent as a network packet to the user node's connected peers, i.e., peer nodes with which the user's node has already established a connection or session. Special codes within a Gnutella message header indicate the type of message, and each type of message has a unique code.

Any node within a certain distance from the user's node in the peer-to-peer network, i.e., within a certain node “hop count”, will receive the query message; there is no mechanism to kill a query. As a query message moves through the connected nodes, a time-to-live (TTL) data field, which represents the hop count, is decremented. If the TTL field reaches zero, then the receiving node should not forward the query message, i.e., it should “drop the packet”. Otherwise, the receiving node forwards the query message.

Each message contains a Globally Unique Identifier (GUID). When a new message is generated, a new GUID is also generated and placed within the new message. The manner in which the GUID is generated is not specifically specified by the Gnutella standard. When any message is received, the GUID is compared to a list of GUIDs, each of which were stored when its corresponding message was received. If the GUID is in the list, this fact indicates that the receiving node has seen this particular message previously because the GUIDs are supposed to be unique. Hence, if the GUID is in the list, then the node should not forward the received message because the receiving node's peer nodes would have also seen the message, and the packet can be dropped.

In addition, if the receiving node can fulfill the query, then the node creates a query hit (query reply) message and returns it to the node that originated the query message. The query hit message contains the address and port number of the responding node so that the originating node can send a message back to the responding node to retrieve a file if desired. The query hit message also contains the connection speed of the responding node and the number of search hits. For each query hit, the query hit message also contains the name of the file that satisfies the query and the size of that file. Other information may be included, such as length of the data content within the message, etc.

Assuming that the originating node has sufficient communication bandwidth, the results of the search should be received within a relatively short amount of time. The search results are stored or cached as they are received. The Gnutella-enabled application then presents the search results to the user in some fashion, and the user may select, through some type of user interface in the application, a filename that the user desires to retrieve. The application, which has stored the search results that include one or more nodes that responded with a search hit, can download a selected file to the user's node. Simple HTTP messages can be used for the download operation, such as a “Get”, a “Put” message (for a Gnutella “Push” request.

The Gnutella protocol operates without a central server. Unlike typical search engines, Gnutella searches anonymously, and there is no index. There is also no authentication process nor authorization process. There are other types of messages within the Gnutella protocol, such as “Ping” and “Pong”, for discovering other nodes on the network and for responding to “Ping” messages. Additionally, a “Push” request message allows a node within the network but behind a firewall to be contacted to push a file to the outside of the firewall rather than attempting to pull the file from inside the firewall. It should be noted that the Gnutella protocol specification is an open standard and is subject to modifications over time.

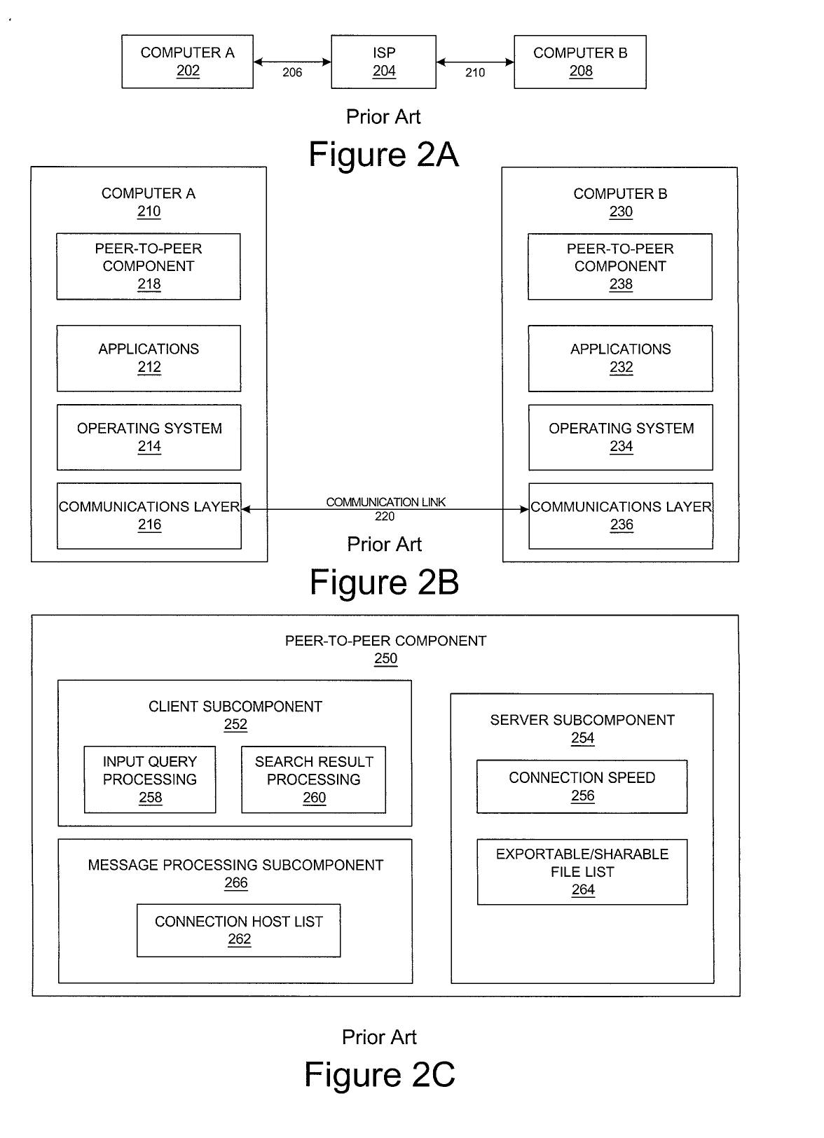

With reference now to FIG. 3, a GUI window for a typical peer-to-peer data sharing application is shown. Window 300 shows information about the operations of a typical peer-to-peer data sharing application that is executing on a given node/host, which may be termed the “source node”. “Host” column 302 shows the addresses of connected nodes/hosts. “Type” column 304 shows whether the connection is an incoming connection or an outgoing connection. At a given node, an incoming connection is a connection that was established by the request of another node; in this case, the given node acts as a server to the other node. An outgoing connection is a connection that was established by the request of the given node; in this case, the given node acts as a client to the other node.

“Info Sent/Recv” column 306 shows the current status of the associated connection, such as whether the connection is idle and merely connected or whether the connection is actively sending or receiving data. “Socket” column 308 shows which socket is being used for the associated connection.

Buttons 310-316 allow a user to view statistical information about the operation of the peer-to-peer data sharing application. User selection of “Connections” button 310 would show a log of the connections that have been made; the connection log might show merely the connections that have been made during the current session or all of the connections that have been made since the connection log was initialized or last cleared. User selection of “Searches” button 312 would show a log of previous searches with information such as the success of the searches, the hosts that had hits for the searches, etc. User selection of “Uploads” button 314 would show a log of the data that has been shared with the source node by retrieving the data from another node/host. User selection of “Downloads” button 316 would show a log of the data that the source node has shared by sending the data to another node/host.

Buttons 318-322 allow a user to initiate an operation. User selection of “Remove” button 318 would allow a user to terminate a currently active connection. User selection of “Add” button 320 would allow a user to attempt to create a new active connection. User selection of “New Search” button 322 would allow a user to enter a new query and initiate a search through the peer-to-peer network.

Other information associated with the operation of the peer-to-peer data sharing application could be shown in window 300: the number of peer-to-peer messages that have been processed; the number of searches on the source node; the number of routing errors; the number of dropped messages; the number of bytes that have been uploaded or downloaded; and any other information concerning the previous operations of the application.

As noted above, depending on the protocol used in the peer-to-peer network, a query hit message usually contains the connection speed of the responding node/host along with the number of search hits, the names of the files associated with the search hits, and the sizes of the files. This information may also be displayed in window 300. However, when a connection is established with another node, a user cannot quickly determine whether or not it is relevant and valuable to the user to browse the content of the newly connected peer node. Since a search may fan out to many nodes, the number of returned file names through which a user would be required to browse can be prohibitive. Searches can often reach nodes that do not contain any content that would be of interest to the user after the user has eventually reviewed the returned information.

In addition, although the fan-out across an entire distributed peer-to-peer network made be large, each node or host has a limited amount of network bandwidth and memory buffer space to dedicate to the peer-to-peer data sharing application. Hence, a given node has a limited number of connections that it can simultaneously support.

By recognizing that eliminating uninteresting or unproductive connections would speed up a user's search for relevant content, the present invention provides a method and system for allowing a user to view connection parameters within a peer-to-peer data sharing network so that the user can limit the connections of the user's node to those nodes that contain relevant or interesting content. A user is also allowed to eliminate unproductive connections to enhance the speed of the search.

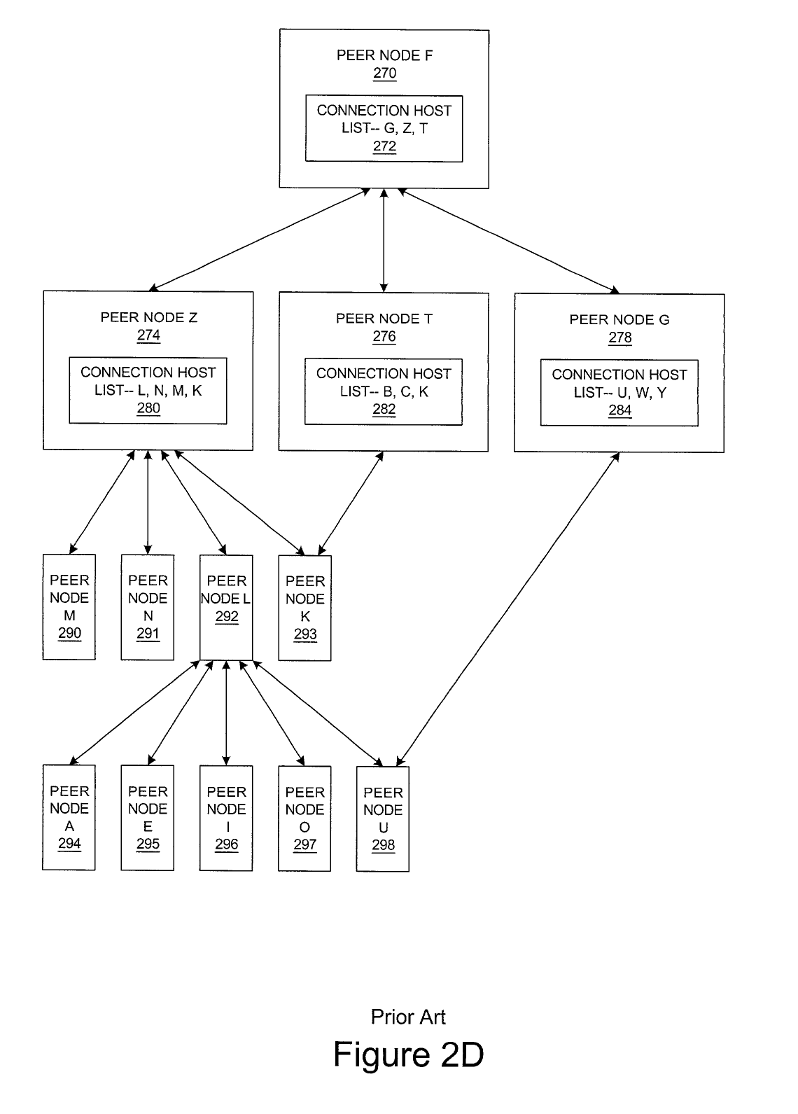

With reference now to FIG. 4, a block diagram depicts a data exchange transaction between two nodes in a peer-to-peer data sharing network in accordance with a preferred embodiment of the present invention. As shown in FIG. 4, the present invention allows the nodes in a peer-to-peer data sharing network to exchange information packets that describe a node's operational characteristics. Node 402 has initiated an outgoing connection with node 404; in response, node 402 sends node characterizing information packet 406 (alternatively termed a “host parameter message” or a “thumbnail message”) to node 404, after which node 404 sends node characterizing information packet 408 to node 402. Thumbnail messages may be exchanged between newly connected nodes, or they may be occasionally or periodically exchanged as the peer-to-peer network protocol allows or the applications or users may desire. The nodes may poll each other to gather the thumbnail information so as to keep the information updated.

In the prior art, the user must rely on the connection speed information that accompanies a query hit message after a search query has been accomplished. In contrast, the present invention performs a data exchange prior to initiating a search. Hence, the present invention allows a user to review the characteristics of a newly connected node/host prior to a search and decide whether the peer-to-peer data sharing application should remain connected to the newly connected node/host or whether the newly connected node/host should be disconnected.

As noted previously, the definition of the peer-to-peer networking protocol can vary depending on the system implementation of a peer-to-peer network. In a system that incorporates the present invention, the thumbnail messages do not necessarily have to be exchanged. In one embodiment, the peer-to-peer data sharing application may have an option that a user may select to determine whether such thumbnail messages are gathered and/or transmitted. If the user does not require such information, then the application would not send requests for such information. As another alternative, the application can provide another user selectable option so that the application automatically drops connections with hosts that do not provide thumbnail messages. By providing these selections, the data traffic on the peer-to-peer network can be reduced and the connections can be optimized.

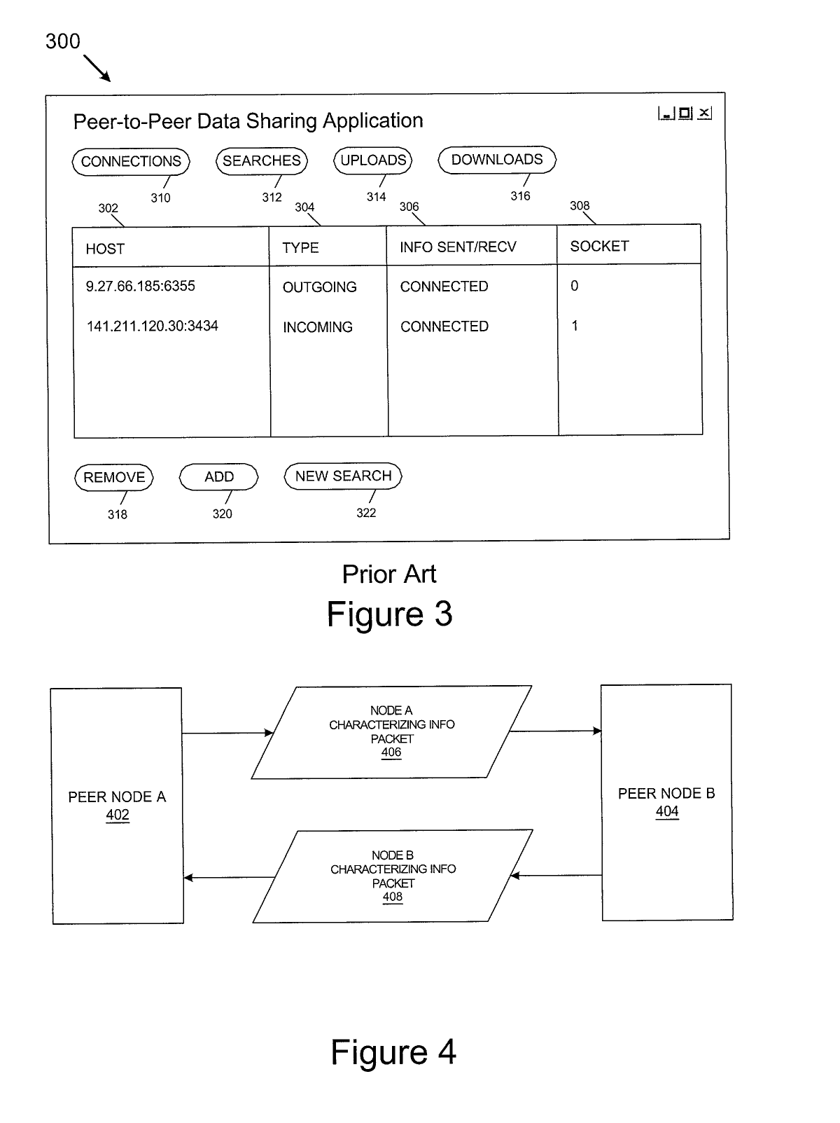

With respect to FIG. 5, the node characterizing information within a thumbnail message is shown in accordance with a preferred embodiment of the present invention. The format of the thumbnail messages may vary but should be well-defined in a standard manner that allows all of the nodes to parse and interpret the messages similarly. Each data item within a thumbnail message may be stored within a single, simple data structure. Alternatively, the node characterizing information may be stored within a single content record in the thumbnail message, but the content record may be a formally structured XML file. The present invention is not limited by the format nor the protocol characteristics of the thumbnail messages.

Node characterizing content 502, also termed the “node thumbnail”, contains a set of data items or parameters that provide node/host characteristics for the characterized node or target node, i.e., the node that is providing the characterizing information. “Optimal connect schedule” data item 504 informs a connected node of the connection time periods during which the characterized node performs best, i.e., those time periods during which the characterized node has experienced the least data traffic and, therefore, the best response times to those nodes that connect to it. Alternatively, the node thumbnail may describe the worst connection periods in a suboptimal connect schedule. As another alternative, the node thumbnail information may describe a simple connect schedule as it should not be assumed that the characterized node is always connected to the peer-to-peer network, in which case the connect schedule might simply provide those times when it is expected that the node will be connected to the peer-to-peer network. These schedule periods might be entered by a user, or the peer-to-peer data sharing application may track actual usage and connection statistics and then report empirically derived time periods.

“Information categories” data item 506 may provide one or more categories, or classes and subclasses, for the types of information that are stored on the characterized node. The information category may be a simple string supplied by the user in which the user provides the most concise definition of the type of information that is being shared by the characterized node. Alternatively, the information category may be empirically derived by scanning the information stored on the characterized node, or the information category may be manually entered by the user in accordance with a standard directory of information categories that is shared by various nodes or supplied as part of the standardization of the peer-to-peer network protocol.

“Information topology” data item 508 provides a snapshot of the types of information that can be found in the nodes that are connected to the characterized node. In other words, the nodes that are connected to the characterized node can also be described by information categories, and the information topology may be a summation of those categories. “Topology link depth” data item 510 provides an indication of the number of hops or links over which the information topology information has been gathered.

The information topology may be viewed as a second-order description of the relevance of the characterized node. For example, the characterized node may purport to reside within the “Medicine” information category. If the user is interested in searching for medical information, then the characterized node would seem to be relevant, and the user should consider remaining connected to the characterized node. However, the information topology may indicate that the characterized node connects to fourteen nodes within the “Geology” information category, five nodes within the “Astronomy” information category, and only one other node within the “Medicine” information category.

In that case, assuming the user remains connected to the characterized node, a medicine-related search query that is sent to the characterized node may result in a search hit at the characterized node with its “Medicine” information category. The characterized node will also forward the search query to its connected nodes/hosts. However, the likelihood of a search hit downstream from the characterized node is reduced because the characterized node connects with only one node within the “Medicine” information category. When the user is made aware of this fact through the present invention, the user will most likely disconnect from the characterized node and attempt to connect with another node in which the likelihood for relevant search hits is increased.

“Supported connection fan-out/fan-in” data item 512 describes the number of nodes/hosts to which the characterized node is currently connected. In addition, an associated data item may provide maximum number/capacity of the nodes to which the characterized node can connect. With this information, the user can determine whether the characterized node is close to its maximum limit of concurrent connections, in which case the characterized node may experience performance problems in attending to search queries.

“Supported connection speed” data item 514 describes the maximum connection speed of the characterized node. In addition, an associated data item may provide the current data traffic load that is being experienced by the characterized node. For example, a characterized node may have a one Mbps (megabits per second) network connection, which may induce the user to remain connected to this node. However, the characterized node may be experiencing a network communication load of 95%, in which case it would be equally beneficial for the user to connect to a node that is only connected to the user's node, i.e. one connection, and has a 56 kbps (kilobits per second) connection speed.

The Gnutella protocol, described above, uses messages that have a header in which a function ID indicates the message type of a packet. A “Ping” message is used to gather information about nodes within the peer-to-peer network, and a “Pong” message is used to reply to a “Ping” message. The “Pong” message contains file characterizing information: the number of files being shared by the node/host that sends the “Pong” message and the total size of those files in bytes.

The present invention may use messages that have headers with a unique function ID for a thumbnail request message and another unique function ID for a thumbnail response in the protocol being used by the peer-to-peer network. Alternatively, the node characterizing content or information may be placed within a Gnutella-like “Pong” message, which would require changing the specification of a “Pong” message. Given the potential size of the node characterizing information, it may be more efficient to create separate function IDs.

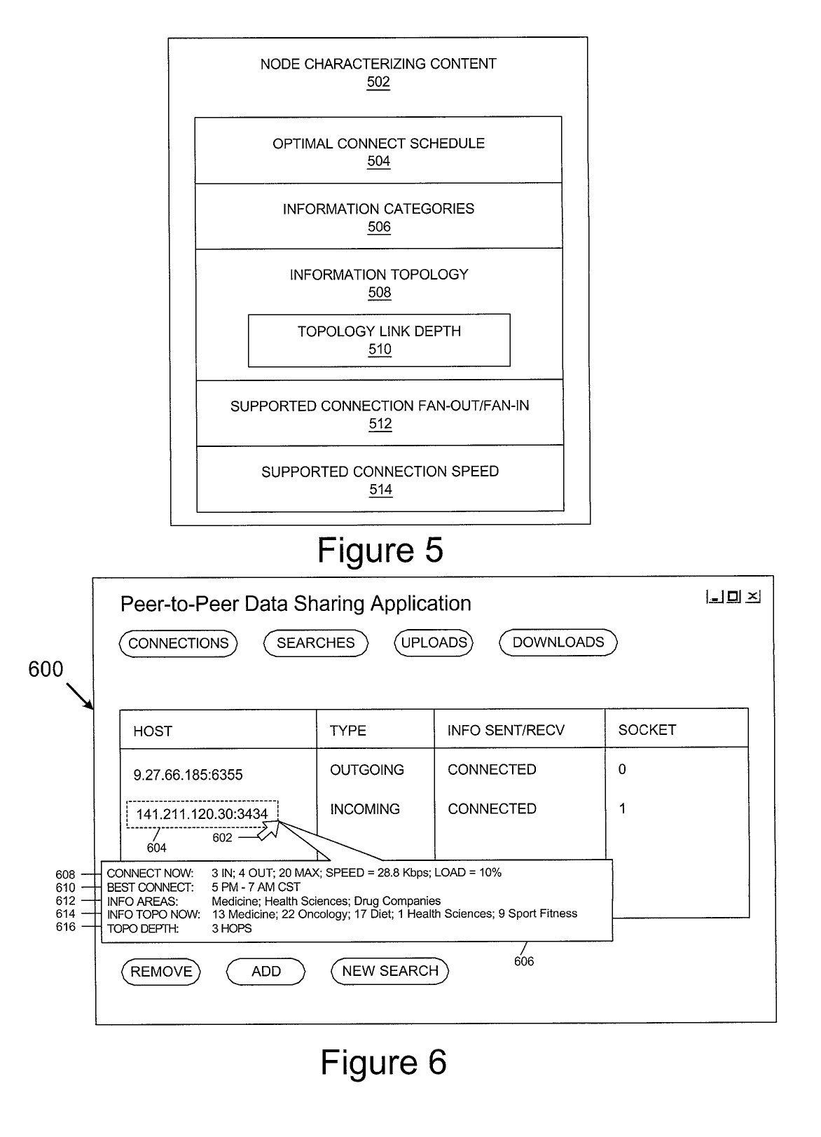

With reference now to FIG. 6, a diagram depicts a GUI window for a peer-to-peer data sharing application in accordance with the present invention. In a manner similar to window 300 in FIG. 3, FIG. 6 shows window 600 with information about the operations of a peer-to-peer data sharing application that is executing on a given node/host, which may be termed the “source node”. As described with respect to FIG. 5, the present invention provides a thumbnail function in the peer-to-peer network protocol that is used by the peer-to-peer data sharing application. At some point either while connecting or after connecting to another node, the peer-to-peer data sharing application sends and/or receives a thumbnail message from the newly connected node. FIG. 6 shows one implementation for displaying node characterizing information or content to a user of the application through the use of a pop-up box. Many different alternative display methods may be used to present the thumbnail information to a user using well-known GUI methodologies.

Display cursor/pointer 602 points to host identifier 604 for an active connection. The user may or may not have previously selected host identifier 604.

When the thumbnail message was received from the node associated with host identifier 604, the application parsed the message and stored the node characterizing data from the message. As pointer 602 moves over host identifier 604, the application detects the screen location of the pointer and retrieves the thumbnail information associated with host identifier 604. The application formats the thumbnail information for presentation purposes. In this case, pop-up box 606 contains data items retrieved from the previously received thumbnail message for the associated host. As the user moves the cursor over other host identifiers, the pop-up box will open and close with the appropriate information.

“Connect Now” line 608 shows the connection status of the characterized node at the time that the node sent the thumbnail message: the number of incoming connections; the number of outgoing connections; the maximum number of connections; the connection speed supported by the node; and the connection load as a percentage of the connection speed. “Best Connect” line 610 shows a schedule for the best connection times at the characterized node. The schedule may show one or more time periods, dates, etc. “Info Areas” line 612 shows the information categories of the information that the characterized node has available for sharing.

“Info Topo Now” line 614 shows the information categories of the information that may be found in the nodes to which the characterized node was connected at the time that the node sent the thumbnail message. It should be noted that the information topology may be stale as this information was supplied by the characterizing node, which might not have updated the node characterizing information of its connected nodes. “Topo Depth” line 616 provides a measure of the depth of the links for which the characterized node has collected characterizing information for the nodes to which it is connected. In this example, the characterized node has gathered characterizing information from nodes that are within three hops in the peer-to-peer network.

By viewing the thumbnail information for the peer nodes to which the user's application has connected, the user can make a judgment as to whether to remain connected to these nodes. Otherwise, the user can select the host identifier for a node from which the user desires to disconnect and then select the “Remove” button. The application will then drop the connect.

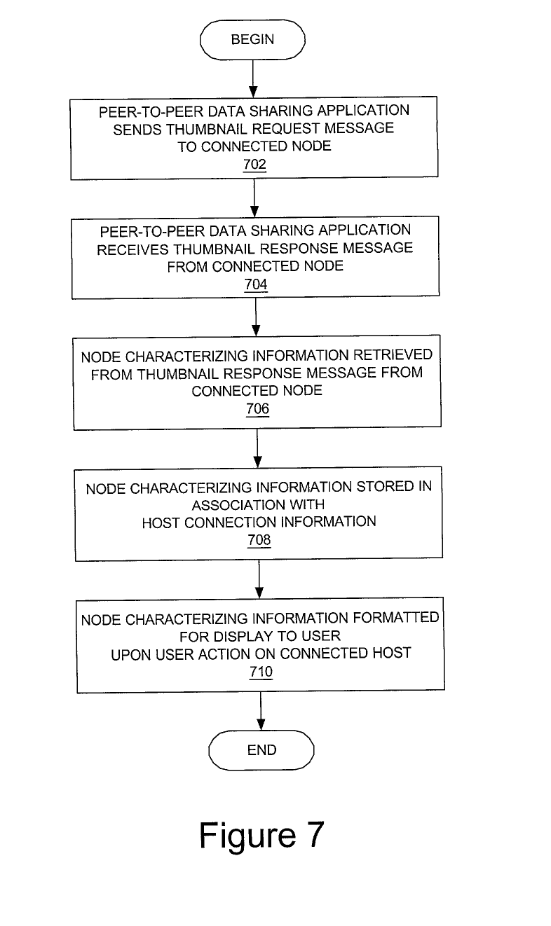

With reference now to FIG. 7, a flowchart depicts a process for gathering and displaying node characterizing information from a node within a peer-to-peer network. The process begins when the peer-to-peer data sharing application sends a thumbnail request message to a node with which the application has previously established a connection (step 702). The application then receives a thumbnail response message from the connected node (step 704). Node characterizing information is retrieved from the thumbnail response message (step 706), and the node characterizing information is stored in association with the host connection information (step 708). Upon certain user actions within the application in association with a host identifier, the application can retrieve the node characterizing information (thumbnail information) for the associated host and display that information to the user (step 710). The process of getting and displaying node characterizing information for a given connected node is then complete.

The advantages of the present invention should be apparent in view of the detailed description of the invention that is provided above. In the prior art, the user must rely on the connection speed information that accompanies a query hit message after a search query has been accomplished.

In contrast, the present invention performs a data exchange prior to initiating a search. Hence, the present invention allows a user to review the characteristics of a newly connected node/host prior to a search and decide whether the peer-to-peer data sharing application should remain connected to the newly connected node/host or whether the newly connected node/host should be disconnected. By providing these selections, the data traffic on the peer-to-peer network can be reduced, and the user's connections and search time are also optimized.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for operating a data sharing application in a peer-to-peer network, wherein the application executes on a source node, the method comprising:
establishing a connection between the source node and a target node in the peer-to-peer network;
receiving node characterizing data from the target node; and
displaying the node characterizing data within the application at the source node.

2. The method of claim 1 further comprising:
automatically requesting the node characterizing data from the target node in response to establishing a connection with the target node.

3. The method of claim 1 wherein the node characterizing data contains an optimal connect schedule.

4. The method of claim 1 wherein the node characterizing data contains an information classification for data available to be shared by the target node.

5. The method of claim 1 wherein the node characterizing data contains information topology data associated with a node connected to the target node.

6. The method of claim 1 wherein the node characterizing data contains information topology data associated with nodes connected to the target node.

7. The method of claim 6 wherein the information topology data is derived from nodes within a specified number of links from the target node.

8. The method of claim 1 wherein the node characterizing data contains connection load data for the target node.

9. The method of claim 8 wherein the connection load data relates to node fan-out or node fan-in at the target node.

10. The method of claim 8 wherein the connection load data relates to a maximum connection load at the target node.

11. The method of claim 8 wherein the connection load data relates to a current connection load at the target node.

12. An apparatus for operating a data sharing application in a peer-to-peer network, wherein the application executes on a source node, the apparatus comprising:
establishing means for establishing a connection between the source node and a target node in the peer-to-peer network;
receiving means for receiving node characterizing data from the target node; and
displaying means for displaying the node characterizing data within the application at the source node.

13. The apparatus of claim 12 further comprising:
requesting means for automatically requesting the node characterizing data from the target node in response to establishing a connection with the target node.

14. The apparatus of claim 12 wherein the node characterizing data contains an optimal connect schedule.

15. The apparatus of claim 12 wherein the node characterizing data contains an information classification for data available to be shared by the target node.

16. The apparatus of claim 12 wherein the node characterizing data contains information topology data associated with a node connected to the target node.

17. The apparatus of claim 12 wherein the node characterizing data contains information topology data associated with nodes connected to the target node.

18. The apparatus of claim 17 wherein the information topology data is derived from nodes within a specified number of links from the target node.

19. The apparatus of claim 12 wherein the node characterizing data contains connection load data for the target node.

20. The apparatus of claim 19 wherein the connection load data relates to node fan-out or node fan-in at the target node.

21. The apparatus of claim 19 wherein the connection load data relates to a maximum connection load at the target node.

22. The apparatus of claim 19 wherein the connection load data relates to a current connection load at the target node.

23. A computer program product on a computer readable medium for use in a data processing system for operating a data sharing application in a peer-to-peer network, wherein the application executes on a source node, the computer program product comprising:
instructions for establishing a connection between the source node and a target node in the peer-to-peer network;
instructions for receiving node characterizing data from the target node; and
instructions for displaying the node characterizing data within the application at the source node.

24. The computer program product of claim 23 further comprising:
instructions for automatically requesting the node characterizing data from the target node in response to establishing a connection with the target node.

25. The computer program product of claim 23 wherein the node characterizing data contains an optimal connect schedule.

26. The computer program product of claim 23 wherein the node characterizing data contains an information classification for data available to be shared by the target node.

27. The computer program product of claim 23 wherein the node characterizing data contains information topology data associated with a node connected to the target node.

28. The computer program product of claim 23 wherein the node characterizing data contains information topology data associated with nodes connected to the target node.

29. The computer program product of claim 28 wherein the information topology data is derived from nodes within a specified number of links from the target node.

30. The computer program product of claim 23 wherein the node characterizing data contains connection load data for the target node.

31. The computer program product of claim 30 wherein the connection load data relates to node fan-out or node fan-in at the target node.

32. The computer program product of claim 30 wherein the connection load data relates to a maximum connection load at the target node.

33. The computer program product of claim 30 wherein the connection load data relates to a current connection load at the target node.
